(19) United States
(12) Patent Application Publication
(10) Pub. No.: US 2009/0241431 A1
(43) Pub. Date: Oct. 1, 2009

(54) Glass run and sealing structure for door vehicle

(75) Inventors: Taizo Shibata, Aichi-ken (JP); Hideaki Minoura, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD, Aichi-ken (JP)

(21) Appl. No.: 12/382,812

(22) Filed: Mar. 24, 2009

(30) Foreign Application Priority Data
Mar. 28, 2008 (JP) P2008-086147
Dec. 25, 2008 (JP) P2008-330355

(51) Int. Cl. E06B 7/16

(52) U.S. Cl. 49/490.1

(57) ABSTRACT

A glass run includes a base part, a body part having a substantially U-shape in cross section and provided with side wall portions extended from the base part, and seal lips extended from substantially tip ends of the respective side wall portions inward into the body part. An entire region of the glass run in a longitudinal direction is formed by extrusion molding. A part of the glass run corresponding to a frame positioned above a belt line is provided with design lips extended from the substantially tip ends of the respective side wall portions outward of the body part. Flange parts of a sash parts DS which is provided along an outer periphery of a window part are clamped between the respective design lips and the side wall portions whereby the glass run is mounted to the sash part. A distance of the glass run from an outer peripheral face of the base part to the tip ends of the side wall portions is 15 mm or less.

### BACKGROUND OF THE INVENTION

1. Field of the Invention

The present invention relates to a glass run and a sealing structure for a door of a vehicle.

2. Related Art

Generally, a door of an automobile is provided with a glass run along an inner periphery of a door frame. As seen in a sectional view, the glass run includes a base part, and a body part having a U-shape in cross section and provided with a vehicle interior side wall portion and a vehicle side wall portion which are extended from the base part. The glass run is further provided with a vehicle interior side seal lip and a vehicle exterior side seal lip which are extended from substantially tip ends of the respective side wall portions inward into the body part. The body part of the glass run is mounted to a mounting part which is provided along the inner periphery of the door frame, and sealed in such a manner that peripheral edges of inner and outer surfaces of a door glass are clamped between the two seal lips.

The glass run in recent years is composed of extruded parts which have been substantially linearly extruded, and molded parts for connecting the extruded parts to each other at a determined angle. The glass run includes, for example, a front vertical part, an upper edge part and a rear vertical part along a shape of the door frame.

However, in case where the glass run is composed of the extruded parts and the molded parts, there is such anxiety that connecting lines between the extruded parts and the molded parts may appear in outer appearance, and color and gloss of their surfaces may be remarkably different between the extruded parts and the molded parts, which may incur deterioration of design performance. Further, there are such anxieties that a step difference may be formed in a boarder part (a connecting part) between the extruded part and the molded part, incurring deterioration of sealing performance, and that molding work is required in addition to extruding work, which may incur increase of production cost and production steps.

For avoiding such anxieties, there has been a prior art in which an entire region in a longitudinal direction of the glass run is formed substantially linearly by extrusion molding, and at the same time, slits are formed in a region corresponding to a corner part, so that the glass run can be mounted to the mounting part by bending the region corresponding to the corner part (Reference should be made to Japanese Patent Publication No. JP-A-2002-274187, for example).

By employing the art disclosed in the above described JP-A-2002-274187, such phenomenon that partial differences in color and gloss may occur in the longitudinal direction of the glass run, or useless step differences may be formed in the longitudinal direction can be avoided. Moreover, because the molding work is not required, reduction of the steps for producing the glass run can be achieved.

However, in the art disclosed in JP-A-2002-274187, although a molding step is not required, a step for partially forming the slits for enabling the glass run to follow a shape of the corner part is required separately. Therefore, it is concerned that this may incur increase of the production steps and the production cost.

### SUMMARY OF THE INVENTION

The invention has been made in view of the above described circumstances, and it is an object of the invention to provide a glass run which can be easily and stably mounted to a mounting part, while enhancement of design performance is achieved and increase of production steps is restrained, and to provide a sealing structure for a door of a vehicle.

Now, means suitable for achieving the above described objects will be described by item. According to necessity, operational effects specific to the corresponding means will be additionally described.

Means 1. A glass run comprising a base part, a body part having a substantially U-shape in cross section and provided with a side wall portion at a vehicle interior side and a side wall portion at a vehicle exterior side which are extended from the base part, and a vehicle interior side seal lip and a vehicle exterior side seal lip which are extended from substantially tip ends of the vehicle interior side wall portion and the vehicle exterior side wall portion inward into the body part,

for a part corresponding to a frame which is provided above a belt line of a door, the glass run including a vehicle interior side design lip and a vehicle exterior side design lip which are extended from the substantially tip ends of the vehicle interior side wall portion and the vehicle exterior side wall portion outward of the body part, and

for a mounting part including a vehicle interior side flange part and a vehicle exterior side flange part which are provided along an inner periphery of a door frame and opposed to each other, the vehicle interior side flange part being clamped between the vehicle interior side design lip and the vehicle interior side wall portion, and the vehicle exterior side flange part being clamped between the vehicle exterior side design lip and the vehicle exterior side wall portion, whereby the glass run is mounted to the mounting part,

wherein an entire region of the glass run in a longitudinal direction including an upper edge part corresponding to an upper edge of a door glass which moves up and down, and a front vertical edge part and a rear vertical edge part corresponding to a front edge and a rear edge of the door glass is continuously formed by extrusion molding, and

a distance from an outer peripheral face of the base part to the tip ends of the side wall portions is 15 mm or less.

By making the distance from the outer peripheral face of the base part to the tip ends of the side wall portions, that is, making the height of the glass run in both inner and outer peripheral directions of the door frame (hereinafter, simply referred to as “the height of the glass run”) 15 mm or less, as in the means 1, it is possible to reduce the distance from a virtual neutral axis of bending at a center of gravity of the glass run in section to end edges of the side wall portions, when the glass run is bent according to the corner part of the mounting part. Specifically, in case where the height of the glass run is larger than 15 mm, the aforesaid distance in the glass run becomes longer, and rigidity is increased in section. Therefore, there is such anxiety that the glass run may not be smoothly deformed following the corner part but deformed with distortion, when the glass run is bent according to the corner part having the radius of curvature smaller than 80 mm, for example. In this respect, by making the height of the glass run 15 mm or less, as in the means 1, it is possible to smoothly bend the glass run according to the corner part, without forming the slits or the like in the glass run, even in case where the radius of curvature of the corner part is smaller than 80 mm, for example. Therefore, such phenomenon that the sectional shape of the glass run may be remarkably distorted with a bending stress (a repulsive force) can be avoided.

In case where the height of the glass run is smaller than 8.6 mm, for example, it is difficult to keep such a sectional shape that a function as the glass run can be maintained, and there is such anxiety that deterioration of the sealing performance and mounting stability may be incurred. In this respect, by making the height of the glass run 8.6 mm or more, such a sectional shape as not deteriorating the sealing performance and the mounting stability can be obtained. As the results, design performance can be enhanced, and at the same time, stable mounting of the glass run, and the sealing performance can be secured. Consequently, it would be preferable to make the height of the glass run 8.6 mm or more and 15 mm or less. It would be more preferable to make the height of the glass run 12.6 mm or more, and 15 mm or less.

Additionally, according to the means 1, the entire region in the longitudinal direction of the glass run is composed of an extruded body. Therefore, different from the glass run formed by connecting a plurality of molded bodies in the longitudinal direction, it is possible to avoid such phenomenon that connecting lines may appear in outer appearance, and difference in color and gloss may occur in the longitudinal direction of the glass run, whereby the design performance is enhanced. Moreover, it is possible to avoid such anxiety that step differences due to connection may be formed in the longitudinal direction of the glass run, and hence, the sealing performance is enhanced in this respect. Further, because molding work is not required, steps required for production are remarkably decreased, and accordingly, enhancement of production efficiency can be achieved.

Still further, because there is no necessity of forming slits or cutouts in the body part and the seal lips so that the glass run may be smoothly bent, reduction of the production steps and the production cost can be achieved, and at the same time, deterioration of the sealing performance and the design performance due to formation of the cutouts or so can be prevented. Still further, because there is no necessity of partially changing sectional shapes and sectional sizes of the glass run in the longitudinal direction, the cost for equipment (an extruder) can be further reduced. It is to be noted that the glass run may be formed having the same sectional shape and the same size in any region in the longitudinal direction, when it is formed by extrusion molding.

According to this means, the vehicle exterior side design lip and the vehicle interior side design lip are provided, and the glass run is mounted to the mounting part, by clamping the vehicle exterior side flange part and the vehicle interior side flange part between the respective design lips and the side wall portions. In short, the glass run is held by the two flange parts, and therefore, the mounted state will not be deteriorated, even though the height of the glass run is made 15 mm or less. It is to be noted that a channel member for connecting the two flange parts need not be provided in the mounting part to which the part corresponding to the frame is mounted.

Means 2. A glass run as described in means 1, characterized in that bottom wall portions of a flange containing part at the vehicle interior side and a flange containing part at the vehicle exterior side which are formed by the vehicle interior side wall portion and the vehicle exterior side wall portion in combination with the vehicle interior side design lip and the vehicle exterior side design lip, and into which the vehicle interior side flange part and the vehicle exterior side flange part can be inserted have a wall thickness of 1.3 mm or more and 1.8 mm or less.

By making the wall thickness of the bottom wall portions of the flange containing parts 1.3 mm or more as in the means 2, such anxiety that the design lips may open outward can be restrained. Therefore, it is possible to secure holding forces for holding the flange parts which are exerted between the side wall portions and the design lips, and hence, the mounted state can be stabilized. Moreover, by making the wall thickness of the bottom wall portions of the flange containing parts 1.8 mm or less, following deformability of the bottom wall portions can be enhanced, and the operational effect of the above described means 1 can be more reliably attained. At the same time, it is possible to easily make the height of the glass run 15 mm or less, while securing a depth of the flange containing parts into which the flange parts are adapted to be inserted.

Means 3. A glass run as described in means 1 or 2, characterized in that the base part has a wall thickness of 1.3 mm or more and 1.8 mm or less.

By making the wall thickness of the base part 1.3 mm or more as in the means 3, it is possible to secure the rigidity to such an extent as not damaging the function as the glass run. Moreover, by making the wall thickness of the base part 1.8 mm or less, the following deformability of the base part can be enhanced, and the operational effect of the above described means 1 can be more reliably attained. At the same time, it is possible to easily make the height of the glass run 15 mm or less, while securing the depth of the body part into which the peripheral edge of the door glass is adapted to be inserted.

According to the means 3, in combination with above described means 2, it is possible to more reliably prevent such phenomenon that the glass run may be deformed with distortion since the glass run is partially made thick-walled, when the glass run is bent according to the corner part.

Means 4. A glass run as described in any one of the means 1 to 3, characterized in that in a state before the glass run is mounted to the mounting part, the vehicle interior side wall portion and the vehicle exterior side wall portion are extended toward an inner peripheral side of the door frame so as to open outward of the body part.

In case where the vehicle interior side wall portion and the vehicle exterior side wall portion are extended toward the inner peripheral side of the door frame so as to be inclined inward into the body part, in a state before the glass run is mounted to the mounting part, such anxiety that the vehicle interior side wall portion and the vehicle exterior side wall portion may be inclined and deformed inward into the body part, when the glass run is bent according to the corner part, is enhanced. In this case, there is such anxiety that deterioration of the design performance and the mounted state may be incurred.

On the other hand, according to the means 4, because the vehicle interior side wall portion and the vehicle exterior side wall portion are extended toward the inner peripheral side of the door frame so as to be inclined outward of the body part, the side wall portions are unlikely to be inclined and deformed inward into the body part, even though the glass run is bent according to the corner part, and hence, it is possible to restrain the above described inconvenience.

Means 5. A glass run as described in any one of means 1 to 4, characterized in that a distance from an outer peripheral face of the base part to the tip ends of the side wall portions 25 is 13 mm or more and 15 mm or less, and the glass run is provided along a window part of the door which has a corner part having a radius of curvature of 50 mm.

Even in case where the glass run is bent according to the corner part as described in the means 5, the glass run can be smoothly deformed following the corner part, by forming the glass run as in the above described means, and it is possible to correctly mount the glass run to the mounting part without incurring deterioration of the design performance. Moreover, the glass run can be correctly mounted to the corner part of the window part having the radius of curvature of 50 mm, and hence, flexibility in designing the window part can be enhanced. As the results, enhancement of the design performance can be achieved.

Means 6. A sealing structure for a door of a vehicle comprising

a glass run which includes a base part, a body part having a substantially U-shape in cross section and provided with a side wall portion at a vehicle interior side and a side wall portion at a vehicle exterior side which are extended from the base part, and a vehicle interior side seal lip and a vehicle exterior side seal lip which are extended from substantially tip ends of the vehicle interior side wall portion and the vehicle exterior side wall portion inward into the body part,

wherein an entire region of the glass run in a longitudinal direction including an upper edge part corresponding to an upper edge of a door glass which moves up and down, and a front vertical edge part and a rear vertical edge part corresponding to a front edge and a rear edge of the door glass is continuously formed by extrusion molding,

the glass run being mounted to a mounting part which is provided along an inner periphery of a door frame,

wherein for a part corresponding to the frame which is provided above a belt line of the door, the glass run is provided with a vehicle interior side design lip and a vehicle exterior side design lip which are extended from the substantially tip ends of the vehicle interior side wall portion and the vehicle exterior side wall portion outward of the body part,

a region of the mounting part to which the part corresponding to the frame is mounted includes a vehicle interior side flange part and a vehicle exterior side flange part which are provided along the inner periphery of the door frame and opposed to each other,

the vehicle interior side flange part is clamped between the vehicle interior side design lip and the vehicle interior side wall portion, and the vehicle exterior side flange part is clamped between the vehicle exterior side design lip and the vehicle exterior side wall portion, whereby the part corresponding to the frame is mounted to the mounting part, and the base part is brought into a non-supported state, and

a distance from an outer peripheral face of the base part to the tip ends of the side wall portions in the glass run is 15 mm or less.

According to the means 6, essentially the same operational effects as in the above described means 1 can be achieved.

Moreover, as for the glass run which is mounted to the mounting part by fitting the body part into a channel member having a substantially U-shape in cross section, for example, it is necessary to form a sectional shape of the glass run according to a shape of the channel member for stabilizing the mounted state. By the way, when the channel member is welded to the flange parts, a tip end part of a device for spot welding (a gun) must be inserted into the channel member, and therefore, the channel member must be inevitably formed relatively largely (deeply). Under the above described circumstances, the glass run becomes relatively large-sized having high rigidity. Therefore, there is such anxiety that the glass run may not be favorably deformed following the shape of the corner part, when the glass run is bent according to the corner part having the small radius of curvature (having the radius of curvature of about 50 mm, for example), and deterioration of the design performance may be incurred.

On the other hand, according to the means 6, the channel member for connecting the vehicle interior side flange part and the vehicle exterior side flange part is not provided in the mounting part to which the part corresponding to the frame is mounted, but the glass run is mounted to the mounting part by clamping the vehicle interior side flange part and the vehicle exterior side flange part between the respective design lips and the side wall portions. In short, such restriction that the sectional shape must be formed according to the shape of the channel member is eliminated, and it is possible to make the glass run relatively smaller (so as to make the height of the glass run 15 mm ), without incurring deterioration of the mounted state. As the results, it is possible to reliably obtain the glass run which can attain the above described operational effects (Even in case where the glass run is bent according to the corner part having the radius of curvature of about 50 mm, it is possible to obtain the glass run which can correctly follow the shape of the corner part, without incurring deterioration of the design performance).

### BRIEF DESCRIPTION OF THE DRAWINGS

FIG. 1 is a schematic front view showing a general structure of a door.

FIG. 2 is a sectional view showing a glass run, taken along a line J-J in FIG. 1.

FIG. 3 is a sectional view showing a glass run which is partly modified in its sectional shape.

### DETAILED DESCRIPTION OF THE PREFERRED EMBODIMENTS

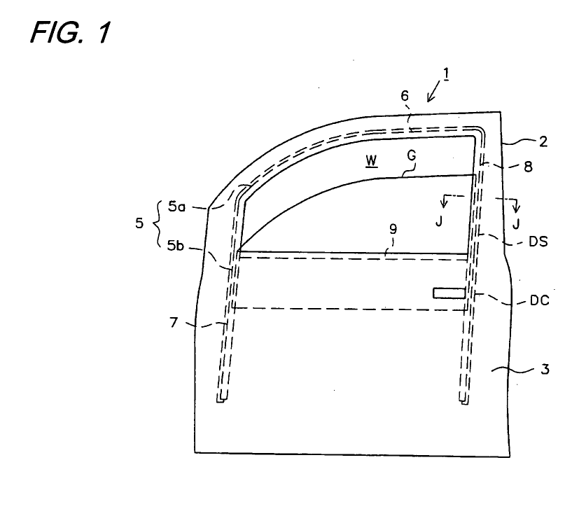

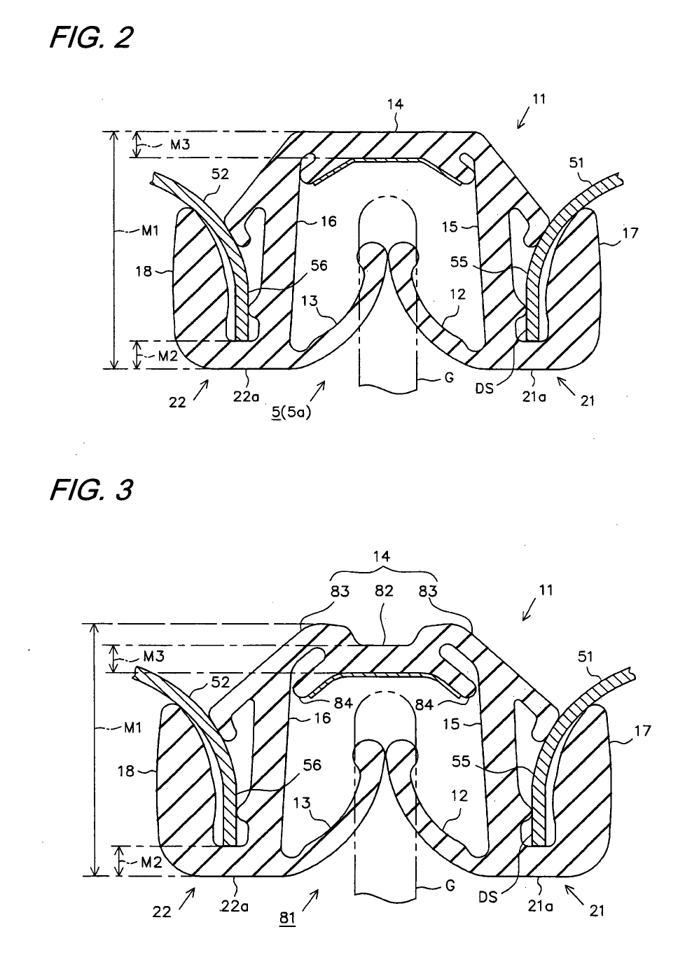

Now, an embodiment of the invention will be described referring to the drawings. FIG. 1 is a schematic front view showing a general structure of a door. FIG. 2 is a sectional view showing a glass run, taken along a line J-J in FIG. 1.

As shown in FIG. 1, a front door which is provided so as to be opened and closed in an open part for a door of an automobile (hereinafter, simply referred to as “door 1”) is provided with a door glass G which is movable up and down, and a glass run 5 which is provided according to an outer peripheral shape of the door glass G, for the purpose of guiding upward and downward movements of the door glass G, and at the same time, for the purpose of sealing a gap between a peripheral edge of the door glass G and a door frame 2, when the door glass G has been moved upward and a window part W has been closed. Moreover, the door 1 is provided with a glass weather strip (a belt line lace 9) along a belt line.

The glass run 5 includes an upper edge part 6 which is a region corresponding to an upper edge of the door glass G, a front vertical edge part 7 which is extended downward from a front end of the upper edge part 6, and a region corresponding to a front edge of the door glass G, and a rear vertical edge part 8 which is extended downward from a rear end of the upper edge part 6, and a region corresponding to a rear edge of the door glass G. The glass run 5 in this embodiment is formed of EPDM (ethylene-propylene-diene copolymer rubber), and the entire region in the longitudinal direction including the front vertical edge part 7, the upper edge part 6, and the rear vertical edge part 8 is formed by extrusion molding. The glass run 5 is mounted to an inner periphery of a sash part DS which is formed along an outer periphery of a window part W (front and rear vertical edges and an upper edge of the window part W) and also to an inner periphery of a channel part DC which is formed in a door panel 3 in such a manner that front and rear vertical edges of the sash part DS are extended downward. In this embodiment, both the sash part DS and the channel part DC correspond to the mounting part.

As shown in FIG. 2, the glass run 5 which is fitted into the sash part DS (the channel part DC) includes a base part 14, a body part 11 having a substantially U-shape in cross section and provided with a vehicle exterior side wall portion 15 and a vehicle interior side wall portion 16 which are extended from the base part 14, a vehicle exterior side seal lip 12 which is extended from the vehicle exterior side wall portion 15 inward into the vehicle, and a vehicle interior seal lip 13 which is extended from a substantially tip end of the vehicle interior side wall portion 16 outward of the vehicle. In a state where the window part W is closed with the door glass G, the vehicle exterior side seal lip 12 is pressure contacted with an outside surface of the door glass G, and the vehicle interior side seal lip 13 is pressure contacted with an inside surface of the door glass G. In this manner, the surfaces of the door glass G at the vehicle exterior side and at the vehicle interior side are respectively sealed.

Additionally, for the purpose of improving sliding performance of the door glass G, surface treatment is applied to an inside face of the base part 14 and sliding faces of the seal lips 12, 13 with respect to the door glass G. As the surface treatment, applying a polyethylene tape, forming a coating film (for example, a urethane coating film), flocking and so on may be conducted.

As shown in FIG. 2, the sash part DS includes a vehicle exterior side flange part 55 and a vehicle interior side flange part 56 which are formed by folding end portions of an outer panel 51 and an inner panel 52 composing the door frame 2 toward an inner peripheral side of the window part W (a lower side in FIG. 2). Specifically, the sash part DS is so constructed that a channel member is not interposed between the outer panel 51 and the inner panel 52 (a channel-less structure). By constructing the sash part DS in this manner, reduction of cost and weight can be achieved.

Moreover, a part of the glass run 5 to be mounted to the sash part DS (hereinafter, referred to as “a part 5a corresponding to the frame”) is provided with a vehicle exterior side design lip 17 which is extended outward of the vehicle from the vehicle exterior side wall portion 15 and a vehicle interior side design lip 18 which is extended inward into the vehicle from the vehicle interior side wall portion 16. A flange containing part 21 into which the vehicle exterior side flange part 55 can be inserted is formed between the vehicle exterior side wall portion 15 and the vehicle exterior side design lip 17, and a flange containing part 22 into which the vehicle interior side flange part 56 can be inserted is formed between the vehicle interior side wall portion 16 and the vehicle interior side design lip 18. By inserting the vehicle exterior side flange part 55 into the vehicle exterior side flange containing part 21, and at the same time, by inserting the vehicle interior side flange part 56 into the vehicle interior side flange containing part 22 such that the body part 11 may be fitted between the vehicle exterior side flange part 55 and the vehicle interior side flange part 56, the vehicle exterior side flange part 55 is clamped between the vehicle exterior side design lip 17 and the vehicle exterior side wall portion 15, and at the same time, the vehicle interior side flange part 56 is clamped between the vehicle interior side design lip 18 and the vehicle interior side wall portion 16. In this manner, the glass run 5 (the part 5a corresponding to the frame) is mounted to the sash part DS.

Moreover, although not shown in the drawings, the channel part DC which is provided below the belt line is extended in a vertical direction along the front and rear vertical edges of the door glass G, and includes a channel member having a substantially U-shape in cross section and a connecting part (not shown) which connects a determined region of the channel member with the inner panel 52.

Further, the vehicle exterior side design lip 17 and the vehicle interior side design lip 18 are not provided in a part of the glass run 5 to be mounted to the channel part DC (hereinafter, referred to as “a part 5b corresponding to the panel”). In this embodiment, the glass run 5 is formed by cutting away (removing) the design lips 17, 18 in the part 5b corresponding to the panel, after the entire region of the glass run 5 in the longitudinal direction has been continuously formed by extrusion molding so that the glass run 5 may have the same sectional shape and the same size (the same wall thickness and the same length) over the entire region in the longitudinal direction. Then, the body part 11 is inserted into the channel member, whereby the glass run 5 (the part 5b corresponding to the panel) is mounted to the channel part DC. It is to be noted that the glass run 5 in this embodiment is symmetrical with respect to its center in a lateral direction.

In this embodiment, a distance from the outer peripheral face of the base part 14 to tip ends of the side wall portions 15, 16 (end edges of the side wall portions 15, 16 at an inner peripheral side of the door frame 2), that is, a height of the glass run 5 (hereinafter, simply referred to as “a height M1 of the glass run 5) in inner and outer peripheral directions (in the vertical direction in FIG. 2) is set to be 13 mm. Moreover, a wall thickness M2 of bottom wall portions 21a, 22a of the vehicle exterior side flange containing part 21 and the vehicle interior side flange containing part 22 is set to be 1.5 mm. Further, a wall thickness M3 of the base part 14 is set to be 1.5 mm.

Moreover, in this embodiment, in a state before the glass run 5 is mounted to the sash part DS (the channel part DC), the vehicle exterior side wall portion 15 and the vehicle interior side wall portion 16 are extended so as to open toward the inner peripheral side of the door frame 2 (downward in FIG. 2). It is to be noted that a radius of curvature of the window part W (the sash part DS) at a backward upper corner part thereof is 50 mm.

As described in detail hereinabove, according to the embodiment, the height M1 of the glass run 5 is set to be 13 mm. By setting the height M1 of the glass run 5 in this manner, it is possible to reduce a repulsive force of the glass run 5, when the glass run 5 is bent according to the corner part of the sash part DS (the window part W, and at the same time, it is possible to realize such a sectional shape that sealing performance and stability of the mounted state may not be damaged. Specifically, in case where the height M1 of the glass run 5 is larger than 15 mm, a distance from a virtual neutral axis of bending the glass run 5 in section to the tip ends of the side wall portions 15, 16, when the glass run 5 is bent according to the corner part, becomes longer, and rigidity of the glass run 5 (in section) is enhanced. Therefore, in case where the glass run 5 is bent according to the corner part having a radius of curvature smaller than 80 mm, for example, there is such anxiety that the glass run 5 cannot be favorably deformed following the curvature, and its sectional shape becomes remarkably distorted. On the other hand, in case where the height M1 of the glass run 5 is smaller than 8.6 mm, it is difficult to obtain such a sectional shape that the function as the glass run 5 can be maintained, and there is such anxiety that deterioration of the sealing performance and stability of the mounted state may be incurred. In this respect, by making the height of the glass run 5 to be 13 mm, as in this embodiment, it is possible to smoothly bend the glass run 5 according to the corner part having the small radius of curvature (as small as 50 mm ), without forming the slits or the like in the glass run 5. Moreover, it is possible to prevent such phenomenon that the function as the glass run may be damaged. As the results, design performance can be enhanced, and at the same time, stabilized mounting and stable sealing performance can be secured.

Additionally, according to the embodiment, the entire region of the glass run in the longitudinal direction is formed of an extruded body. Therefore, different from a case where the glass run is formed by connecting a plurality of molded bodies in the longitudinal direction, it is possible to avoid such phenomenon that the connection lines may appear in outer appearance, or color and gloss of the glass run may become different partially in the longitudinal direction of the glass run, and hence, the design performance is enhanced. Further, it is possible to avoid such anxiety that step differences due to connection are formed in the longitudinal direction of the glass run, and hence, the sealing performance is enhanced in this respect. Still further, because molding work is not required, remarkable reduction of the steps required for production, and accordingly, improvement of production efficiency can be achieved.

Moreover, because it is unnecessary to form slits or cutouts in the body part 11 and in the seal lips 12, 13, for example, for the purpose of smoothly bending the glass run 5, reduction of the production steps and production cost can be achieved, and deterioration of the sealing performance and design performance due to formation of the cutouts or the like can be prevented. Further, because the shape and size of the glass run need not be partially changed in the longitudinal direction, further reduction of the cost for equipment (an extruder) can be achieved.

In the glass run of such a type that the design lips 17, 18 are not provided, and the glass run is held in the sash part DS by fitting the body part 11 into the channel member having a substantially U-shape in cross section which connects the vehicle exterior side flange part 55 and the vehicle interior side flange part 56, the sectional shape of the glass run must be formed according to the shape of the channel member in order to stabilize the mounted state. By the way, the channel member must be inevitably formed relatively largely (deeply), because a tip end of a device for spot welding (gun) must be inserted into the channel member, when the channel member is welded to the flange parts 55, 56. Under the circumstances, the glass run is made relatively large-sized having high rigidity, and there is such anxiety that when the glass run is bent according to the corner part having a small radius of curvature (having the radius of curvature of about 50 mm, for example), the glass run cannot be favorably deformed following the shape of the corner part, and deterioration of the design performance may be incurred.

On the other hand, in this embodiment, the channel member as described above is not provided in the sash part DS, and the glass run 5 (the part 5a corresponding to the frame) is mounted to the sash part DS, by clamping the vehicle exterior side flange part 55 and the vehicle interior side flange part 56 respectively between the design lips 17, 18 and the side wall portions 15, 16. In short, there is no such restriction that the sectional shape of the glass run must be formed according to the shape of the channel member. Therefore, it is possible to make the glass run 5 relatively smaller (so that the height of the glass run 5 may be 13 mm), without incurring deterioration of the mounted state. As the results, it is possible to reliably obtain the glass run 5 which can attain the above described operational effects (Even in case where the glass run is bent according to the corner part having the radius of curvature of about 50 mm, it is possible to obtain the glass run 5 which can correctly follow the corner part, without incurring deterioration of the design performance).

Moreover, because the wall thickness M2 of the bottom wall portions 21a, 22a of the flange containing parts 21, 22 is 1.5 mm, following deformability of the bottom wall portions 21a, 22a can be enhanced, and the above described operational effects can be more reliably achieved. In addition, it is possible to make the height M1 of the glass run 5 to be 13 mm, while securing a depth of the flange containing parts 21, 22 into which the flange parts 55, 56 are respectively inserted. At the same time, such anxiety that the design lips 17, 18 are deformed so as to open outward can be restrained. Therefore, it is possible to secure holding forces for holding the flange parts 55, 56 which are exerted between the side wall portions 15, 16 and the design lips 17, 18, and hence, the mounted state can be stabilized.

Further, because the wall thickness M3 of the base part 14 is 1.5 mm, following deformability of the base part 14 can be enhanced, and the above described operational effects can be more reliably achieved. In addition, it is possible to make the height M1 of the glass run 5 to be 13 mm, while securing a depth of the body part 11 into which the peripheral edge of the door glass G is inserted. At the same time, it is possible to secure the rigidity of the base part 14 to such an extent that the function as the glass run may not be damaged.

In case where the vehicle exterior side wall portion 15 and the vehicle interior side wall portion 16 are extended so as to be inclined inward into the body part 11 toward the inner peripheral side of the door frame 2 (the window part W), in a state before the glass run 5 is mounted to the sash part DS, such anxiety that the vehicle exterior side wall portion 15 and the vehicle interior side wall portion 16 may be further inclined and deformed inward into the body part 11, when the glass run 5 is bent according to the corner part, is enhanced. In this case, there is such anxiety that deterioration of the design performance and the mounted state may be incurred.

On the other hand, in this embodiment, the vehicle exterior side wall portion 15 and the vehicle interior side wall portion 16 are extended so as to be inclined outward of the body part 11 toward the inner peripheral side of the door frame 2. Therefore, the side wall portions 15, 16 are unlikely to be inclined and deformed inward into the body part 11, even though the glass run 5 is bent according to the corner part, and hence, it is possible to restrain the above described inconvenience.

Then, in order to confirm the operational effects which are achieved in this embodiment, bending stress tests for measuring stresses exerted on the glass run 5, in case where the glass run 5 is bent according to the corner part having the radius of curvature of 50 mm, varying the height M1 of the glass run 5, have been conducted. It is to be noted that the wall thickness M2 of the bottom wall portions 21a, 22a of the flange containing parts 21, 22 and the wall thickness M3 of the base part 14 are the same with respect to all the glass runs.

Table 1 shows data of bending stress tests conducted on the glass run having such a sectional shape as shown in FIG. 2.

TABLE 1

| | M1 (mm) | | | | |
|---|---|---|---|---|---|
| | 8 | 13 | 14 | 15 | 16 |
| Tensile | — | 0.611 | 0.654 | 0.681 | 0.730 |
| Stress (MPa) | | | | | |
| Compression | — | 0.578 | 0.586 | 0.625 | 0.641 |
| Stress (MPa) | | | | | |
| Sealing | NG | GOOD | GOOD | GOOD | GOOD |
| Performance | | | | | |

As shown in Table 1, in case where the glass run 5 having the height M1 of 13 mm was bent, the largest value of tensile stress which was mainly exerted on the region at the outer peripheral side of the door frame 2 was 0.611 MPa, and the largest value of compressive stress which was mainly exerted on the region at the inner peripheral side of the door frame 2 was 0.578 MPa. In case where the glass run 5 having the height M1 of 14 mm was bent, the largest value of the tensile stress was 0.654 MPa, and the largest value of the compressive stress was 0.586 MPa. In case where the glass run 5 having the height M1 of 15 mm was bent, the largest value of the tensile stress was 0.681 MPa, and the largest value of the compressive stress was 0.625 MPa. In case where the glass run 5 having the height M1 of 16 mm was bent, the largest value of the tensile stress was 0.730 MPa, and the largest value of the compressive stress was 0.641 MPa.

Moreover, it is proved from FEM calculation (ABAQUS is employed as an analyzing software) that in case where the glass run 5 is mounted to the sash part DS, the glass rune 5 cannot be smoothly deformed following the corner part, in case where either one of the tensile stress and the compressive stress exerted on the glass run 5 exceeds 0.700 MPa, and deterioration of the mounting workability (assembling performance) is incurred. Further, in case where either one of the tensile stress and the compressive stress exceeds 0.700 MPa, residual stress at the time of assembling is increased, and deformation of the seal lips 12, 13 may occur in some cases, resulting in deterioration of the sealing performance.

As described above, it has been substantiated that by making the height M1 of the glass run 5 to be 15 mm or less, either one of the tensile stress and the compressive stress exerted on the glass run 5 does not exceed 0.700 MPa, and therefore, it is possible to avoid such inconvenience that deterioration of the mounting workability (the assembling performance) may be incurred. In case where the glass run 5 having the height M1 of 8 mm is bent, both the tensile stress and the compressive stress exerted on the glass run 5 were below 0.700 MPa, and there is no problem in the mounting workability. However, the two seal lips 12, 13 must be made shorter because the inner space of the body part 11 is narrow, and there is such anxiety that lack of seal may occur between the door glass G and the seal lips 12, 13, according to cases.

Moreover, the similar bending stress tests have been also conducted on the glass run 81 having such a sectional shape as shown in FIG. 3. Because the glass run 81 has the same basic structure as the above described glass run 5, description of the basic structure is omitted, and the same terms and reference numerals of the members will be used in the following description.

The base part 14 of the glass run 81 as shown in FIG. 3 has a shape of a substantially flat plate, and includes a contact region 82 to be contacted with the outer peripheral edge of the door glass G, modified connecting portions 83 which connect the contact region 82 to the respective side wall portions 15, 16. The modified connecting portions 83 are made thinner in wall thickness than the contact region 82 and the two side wall portions 15, 16. At the same time, the modified connecting portions 83 have determined lengths in the lateral direction of the vehicle and in the inner and outer peripheral directions of the door frame 2, and a substantially J-shape in cross section. In case where the glass run 81 is curved according to the corner part of the window part W when it is mounted, the base part 14 (the contact region 82) is displaced toward the inner peripheral side of the window part W, because of presence of the modified connecting portions 83. The displacement of the base part 14 is guided by guide lips 84 which are extended from both side edges of the contact region 82 respectively towards the side wall portions 15, 16, having their tip ends substantially brought into contact with the side wall portions 15, 16.

It is to be noted that the wall thickness M2 of the bottom wall portions 21a, 22a of the vehicle exterior side flange containing part 21 and the vehicle interior side flange containing part 22, and the wall thickness M3 of the base part 14 are 1.5 mm, in the same manner as in the above described glass run 5. Moreover, the height M1 of the glass run 81 in both the inner and outer peripheral directions of the door frame 2 (the window part W) is a distance from the outer peripheral edges of the modified connecting portions 83 (regions of the outer peripheral face of the base part 14 which are positioned most outward of the door frame 2) to the tip ends of the side wall portions 15, 16. In addition, a distance from the outer peripheral edges of the modified connecting portions 83 to the outside face of the contact region 82 is 2 mm or less.

Table 2 shows data of bending stress tests conducted on the glass run having such a sectional shape as shown in FIG. 3.

TABLE 2

| | M1 (mm) | | | | | |
|---|---|---|---|---|---|---|
| | 10 | 12 | 14 | 15 | 16 | 18 |
| Tensile | 0.4963 | 0.5433 | 0.6287 | 0.670 | 0.6900 | 0.7470 |
| Stress (MPa) | | | | | | |
| Compressive | 0.4635 | 0.5709 | 0.6284 | 0.661 | 0.7079 | 0.7722 |
| Stress (MPA) | | | | | | |

Now, in case where the glass run 81 having the height M1 of 10 mm was bent according to the corner part having the radius of curvature of 50 mm, the largest value of the tensile stress which was mainly exerted on the region of the door frame 2 at the outer peripheral side was 0.4963 MPa, and the largest value of the compressive stress which was mainly exerted on the region of the door frame 2 at the inner peripheral side was 0.4635 MPa, as shown in Table 2. In case where the glass run 81 having the height M1 of 12 mm was bent, the largest value of the tensile stress was 0.5433 MPa, and the largest value of the compressive stress was 0.5709 MPa. In case where the glass run 81 having the height M1 of 14 mm was bent, the largest value of the tensile stress was 0.6287 MPa, and the largest value of the compressive stress was 0.6284 MPa. In case where the glass run 81 having the height M1 of 15 mm was bent, the largest value of the tensile stress was 0.670 MPa, and the largest value of the compressive stress was 0.661 MPa. In case where the glass run 81 having the height M1 of 16 mm was bent, the largest value of the tensile stress was 0.9600 MPa, and the largest value of the compressive stress was 0.7079 MPa. In case where the glass run 81 having the height M1 of 18 mm was bent, the largest value of the tensile stress was 0.7470 MPa, and the largest value of the compressive stress was 0.7722 MPa.

As described above, in the glass run 81 as shown in FIG. 3, both the tensile stress and the compressive stress exerted on the glass run 81, when it is mounted, did not exceed 0.700 MPa, and it has been proved that such inconveniences as incurring deterioration of the mounting workability (the assembling performance) can be avoided.

The invention is not limited to the description of the above described embodiment, but may be carried out, for example, as follows. Naturally, other examples of application and other examples of modification which are not described below can be also carried out.

(a) Although the height M1 of the glass run 5 is 13 mm in the above described embodiment, substantially the same operational effects as in the above described embodiment can be essentially achieved, provided that the M1 is 8.6 mm or more and 15 mm or less. Further, the height M1 of the glass run 5 may be 12.6 mm or more and 15 mm or less. In this case, the assembling performance (stability) of the door glass G can be enhanced. Moreover, although the wall thickness M2 of the bottom wall portions 21a, 22a of the flange containing parts 21, 22 is 1.5 mm, it would be sufficient that this may be 1.3 mm or more and 1.8 mm or less. Further, although the wall thickness M3 of the base part 14 is 1.5 mm, it would be sufficient that this may be 1.3 mm or more and 1.5 mm or less.

(b) Although the glass run 5 is symmetrical with respect to the center in the lateral direction in the above described embodiment, the glass run 5 need not necessarily be symmetrical.

(c) Although the glass run 5 is formed of EPDM in the above described embodiment, it is also possible to form the glass run 5 out of other material such as olefin type thermoplastic elastomer (TPO). Moreover, although the glass run 5 for the front door has been particularly described in detail, it is also possible to form the glass run for the rear door in the same manner.

What is claimed is:

1. A glass run comprising:
a base part;
a body part having a substantially U-shape in cross section and provided with a vehicle interior side wall portion at a vehicle interior side and a vehicle exterior side wall portion at a vehicle exterior side which are extended from said base part; and
a vehicle interior side seal lip and a vehicle exterior side seal lip which are extended from substantially tip ends of said vehicle interior side wall portion and said vehicle exterior side wall portion inward into said body part;
wherein, for a part corresponding to a frame which is provided above a belt line of a door, said glass run including a vehicle interior side design lip and a vehicle exterior side design lip which are extended from the substantially tip ends of said vehicle interior side wall portion and said vehicle exterior side wall portion outward of said body part, and
for a mounting part including a vehicle interior side flange part and a vehicle exterior side flange part which are provided along an inner periphery of a door frame and opposed to each other, said vehicle interior side flange part being clamped between said vehicle interior side design lip and said vehicle interior side wall portion, and said vehicle exterior side flange part being clamped between said vehicle exterior side design lip and said vehicle exterior side wall portion, whereby said glass run is mounted to said mounting part,
wherein an entire region of said glass run in a longitudinal direction including an upper edge part corresponding to an upper edge of a door glass which moves up and down, and a front vertical edge part and a rear vertical edge part corresponding to a front edge and a rear edge of said door glass is continuously formed by extrusion molding, and
a distance from an outer peripheral face of said base part to the tip ends of said side wall portions is 15 mm or less.

2. A glass run as claimed in claim 1, wherein bottom wall portions of a flange containing part at the vehicle interior side and a flange containing part at the vehicle exterior side which are formed by said vehicle interior side wall portion and said vehicle exterior side wall portion in combination with said vehicle interior side design lip and said vehicle exterior side design lip, and into which said vehicle interior side flange part and said vehicle exterior side flange part are inserted have a wall thickness of 1.3 mm or more and 1.8 mm or less.

3. A glass run as claimed in claim 1, wherein said base part has a wall thickness of 1.3 mm or more and 1.8 mm or less.

4. A glass run as claimed in claim 1, wherein in a state before said glass run is mounted to said mounting part, said vehicle interior side wall portion and said vehicle exterior side wall portion are extended toward an inner peripheral side of the door frame so as to open outward of said body part.

5. A glass run as claimed in claim 1, wherein a distance from an outer peripheral face of said base part to the tip ends of said side wall portions is 13 mm or more and 15 mm or less, and said glass run is provided along a window part of the door which has a corner part having a radius of curvature of 50 mm.

6. A sealing structure for a door of a vehicle comprising:
a glass run which includes a base part, a body part having a substantially U-shape in cross section and provided with a vehicle interior side wall portion at a vehicle interior side and a vehicle exterior side wall portion at a vehicle exterior side which are extended from said base part, and a vehicle interior side seal lip and a vehicle exterior side seal lip which are extended from substantially tip ends of said vehicle interior side wall portion and said vehicle exterior side wall portion inward into said body part,
wherein an entire region of said glass run in a longitudinal direction including an upper edge part corresponding to an upper edge of a door glass which moves up and down, and a front vertical edge part and a rear vertical edge part corresponding to a front edge and a rear edge of said door glass is continuously formed by extrusion molding,
said glass run being mounted to a mounting part which is provided along an inner periphery of a door frame,
wherein for a part corresponding to the frame which is provided above a belt line of the door, said glass run is provided with a vehicle interior side design lip and a vehicle exterior side design lip which are extended from the substantially tip ends of said vehicle interior side wall portion and said vehicle exterior side wall portion outward of said body part,
a region of said mounting part to which said part corresponding to the frame is mounted includes a vehicle interior side flange part and a vehicle exterior side flange part which are provided along the inner periphery of the door frame and opposed to each other,
said vehicle interior side flange part is clamped between said vehicle interior side design lip and said vehicle interior side wall portion, and said vehicle exterior side flange part is clamped between said vehicle exterior side design lip and said vehicle exterior side wall portion, whereby said part corresponding to the frame is mounted to said mounting part, and said base part is brought into a non-supported state, and a distance from an outer peripheral face of said base part to the tip ends of said side wall portions in said glass run is 15 mm or less.
